(19) United States
(12) Patent Application Publication
(10) Pub. No.: US 2018/0101088 A1
(43) Pub. Date: Apr. 12, 2018

(54) 360-DEGREE PRODUCTION LIGHT

(71) Applicant: Scott Lee Robinson, San Diego, CA (US)

(72) Inventor: Scott Lee Robinson, San Diego, CA (US)

(21) Appl. No.: 15/782,761

(22) Filed: Oct. 12, 2017

Related U.S. Application Data
(60) Provisional application No. 62/407,402, filed on Oct. 12, 2016.

(51) Int. Cl. G03B 21/20; F21V 15/01

(52) U.S. Cl. CPC G03B 21/2033; F21Y 2107/30; F21V 15/01

(57) ABSTRACT

In an embodiment of the present invention, a production light is provided to be attached to the bottom of a camera, via a threaded aperture, typically used to mount a camera to a tripod. The production light is configured to emit light about a 360-degree angle via a light emitting diode (LED) array.

### CROSS-REFERENCE TO RELATED APPLICATION(S)

The present application claims priority to U.S. Provisional Patent Application No. 62/407,402 filed on Oct. 12, 2016, entitled “360-DEGREE PRODUCTION LIGHT” the entire disclosure of which is incorporated by reference herein.

### BACKGROUND OF THE INVENTION

### 1. Field of Invention

The present invention relates to the field of video production lighting, and more specifically to 360-degree lights designed to aid in the production of virtual reality films.

### 2. Description of Related Art

Appropriate lighting on a film set can help immerse a viewer into the story and film. Proper lighting may be readily accomplished in a standard indoor studio scenario, as lighting is usually already set up. But for outdoor shooting and untraditional scene sets, obtaining the proper lighting may prove to be a large challenge. If lighting on a set is poor, a viewer may have difficulties seeing and understanding what is happening in the film. This may lead to a poor viewing experience for watchers, regardless of how great the storyline, acting, and directing are.

In recent years, virtual reality films have started to gain popularity and momentum as virtual reality technology continues to improve. The challenge of immersing an audience into the film becomes even greater with the introduction of virtual reality, as much of the time the film is to be shot as if the viewer were actually a part of the scene and storyline. With the goal of full immersion in mind, the task of achieving proper lighting on a set becomes even more crucial.

When shooting a film intended for a virtual reality format, videographers often use a 360-degree camera. These specially designed cameras use multiple lens, in some cases multiple cameras, to capture an entire 360-degree view all in one shot. This allows the 360-degree view to be captured without having to stage multiple sets and try to match exact placements. The 360-degree capturing of video presents an additional challenge of hiding lighting equipment, such that the equipment is not captured in the shot. Yet, the lighting must still be able to illuminate the entire 360-degree range.

There are 360-degree lighting systems that are available, but they are not designed for film production scenarios. What is available is typically meant for use in emergency lighting and general lighting purposes, so the color temperature is not well balanced and does not have the same aesthetics as production lighting. There are also production lighting systems that utilize multiple lights to obtain a 360-degree projection, but require special, bulky, and expensive mounting equipment. Additionally, much of the lighting equipment available that may be adapted to provide 360-degree lighting must be plugged into an outlet. This can greatly limit the scenarios in which the lights may be used.

Based on the foregoing, there is a need in the art for a lighting system with a 360-degree projection. What might be further desired is a 360-degree lighting system that is portable, battery operated, and runs with a color temperature attributed to film production.

### SUMMARY OF THE INVENTION

In an embodiment of the present invention, a production light is provided. In the embodiment, the production light incorporates a light emitting diode (LED) array, an internal power source, and a threaded connector provided above the light emitting diode array. The production light is configured such that the light projects from the light emitting diode array about a 360-degree angle. Furthermore, the production light is configured to receive the threaded aperture provided at the bottom of camera.

In an embodiment, the production light is further provided with a top lid above the LED array, and a bottom lid below the LED array. In a further embodiment, the top lid is configured with a light shield disc to prevent light emitted the production light from directly entering the lens of an attached camera.

In an embodiment, the bottom lid is further provided with a display. In another embodiment, the bottom lid is also provided with a power switch, which is able to adjust the light intensity emitted by the LED array.

In an embodiment, the production light is further configured with a transparent guard to be held between the top and bottom lids. In an embodiment, the transparent guard is configured as a light or optical filter.

In an embodiment, the internal power source of the production light is one or more batteries. In an embodiment, the batteries are rechargeable type batteries.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the 360-degree production light, according to an embodiment of the present invention;

FIG. 2 is an exploded view of the 360-degree production light, according to an embodiment of the present invention;

FIG. 3 is a perspective view of the 360-degree production light with the shell and guard components removed, according to an embodiment of the present invention; and

FIG. 4 is a perspective view of the 360-degree production light, according to an embodiment of the present invention.

### DETAILED DESCRIPTION OF PREFERRED EMBODIMENTS

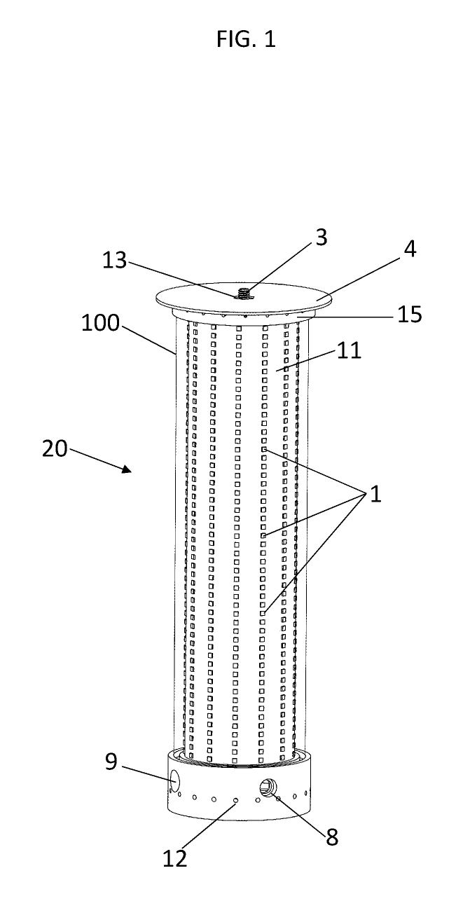

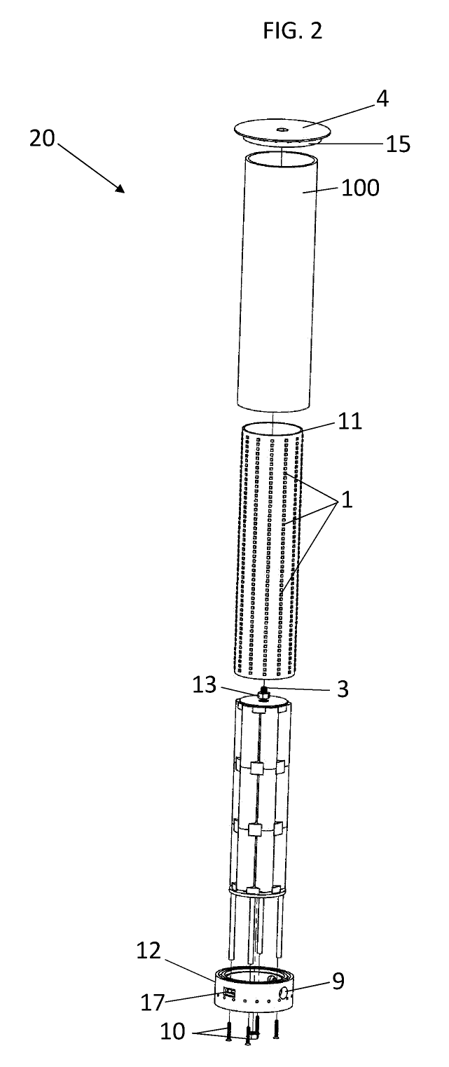

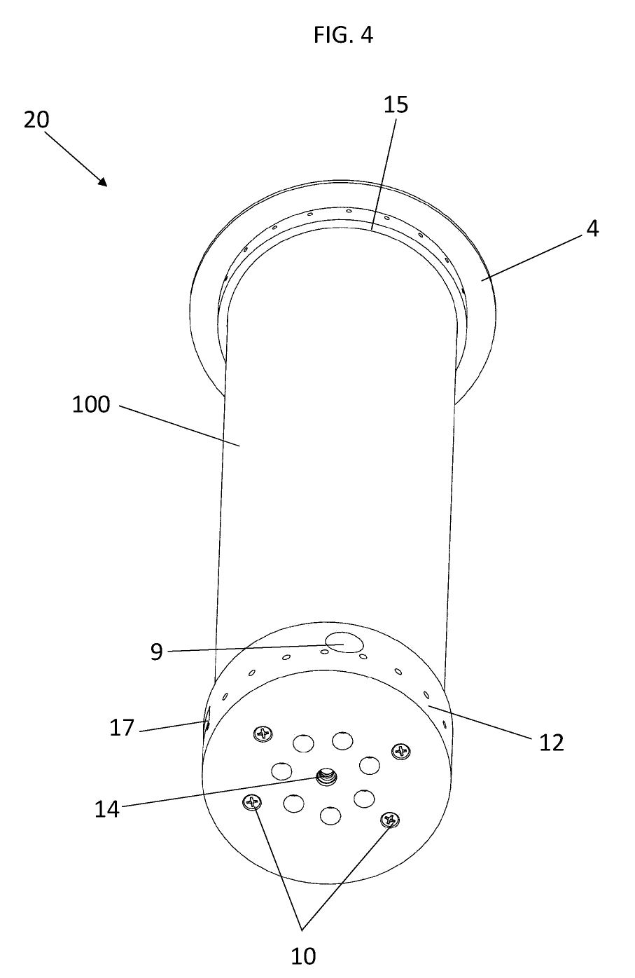

Preferred embodiments of the present invention and their advantages may be understood by referring to FIGS. 1-4, wherein like reference numerals refer to like elements.

In reference to FIGS. 1-4, an embodiment of the 360-degree production light is shown provided with a plurality of light emitting diodes (LED) 1. In an embodiment, the LED's are arranged on a flexible mat that is adhered to a shell 11. The shell is provided to give support and structure to the 360-production light. The shell may be made out of a rigid material such as plastic, metal, composite, or another material deemed appropriate by one skilled in the art. In another embodiment, the LEDs 1 are adhered directly onto the shell 11. In another embodiment, no adhesive is used to attach the LEDs 1 to the shell 11, instead the tension of LEDs 1 wrapped around the shell 11 keeps the LEDs 1 in place relative to the shell 11. In another embodiment, the LEDs 1 are integrated within the shell 11. In one embodiment, the LEDs 1 are SMD5630 LEDs. In another embodiment the light source is any type deemed suitable for the application.

In an embodiment, the 360-degree production light is further provided with a transparent guard 100 provided to protect the internal components of the production light while allowing essentially all light from the LEDs to project. In an embodiment, the transparent guard 100 is plexi-glass or a transparent plastic. In another embodiment, the transparent guard may be made of one or more other materials deemed suitable.

In some embodiments, a lighting apparatus 20 is further provided with a phosphor film integrated with the transparent guard to surround the LEDs 1. In the embodiment the phosphors film is provided as a filter for the light emitted by the LEDs 1. In another embodiment, the phosphor film is provided as an additional sleeve to be placed between the transparent guard and the LEDs. In an embodiment, user may interchange filter sleeves or use multiple film sleeves of different filter types to appropriate suit the setting, as is known in the art.

In yet another embodiment, the 360-degree production light 20 is provided with a threaded attachment 3 to be threaded into a threaded cavity provided on the bottom of a camera or camera housing. In an embodiment, the threaded attachment 3 is a ¼″-20 thread as is commonly used with camera receptacles. In such an embodiment, the threaded attachment 3 is provided in the center of the 360-degree production light such that it is balanced when attached to a camera. The attachment 3 may provide a positioning such that the 360-degree production light will be placed in the blind spot of a 360-degree camera.

In an embodiment, the 360-degree production light is provided with a light top cap 15 placed onto the top of the shell 11. The top cap 15 may be further provided with a protruding light shield disc 4 to prevent light from being projected directly from the 360-degree production light into the lens of an attached camera. This placement may prevent a solar flare or lens flare effect, for example. In an embodiment, top cap 15 is able to be removed and replaced such that a user can place top caps with various sized light shield discs 4 to shield camera lenses of different sizes from a solar flare effect. In another embodiment, the provided light shield disc 4 will be able to expand, such that one disc can be altered to accommodate a variety of camera types and sizes. In an embodiment, the top cap 15 is fastened to the shell 11 by a bolt 13 which is threaded onto the threaded attachment 3 and tightens down onto the cap 15.

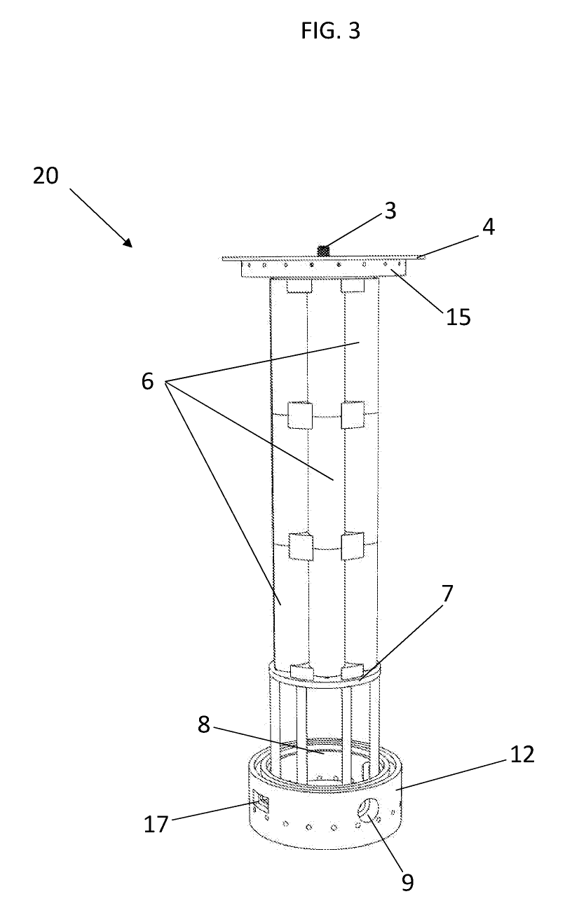

In an embodiment, the 360-degree production light is to be powered by one or more batteries 6 to be placed inside a battery frame 7. FIG. 3 illustrates the production light with shell 11 and transparent guard 100 removed, such that the batteries are visible. In an embodiment, the batteries 6 are removable, wherein a user may to remove the top cap 15 to access and remove the batteries. In the embodiment, the batteries provided may be disposable or rechargeable. In another embodiment, the batteries provided may be of a more permanent type, such as a battery pack with rechargeable cells therein. In the embodiment, the batteries may be recharged by connecting an external power source (not shown) charging port 8. In an embodiment, the input port is universal serial bus (USB) compatible. Also, in an embodiment, the 360-degree production light may be powered by an external power source (not shown) to the charging port 8 as an alternative to battery-powered operation. In an embodiment, the production light is able to provide power to and charge an external device, such as a camera, via a charging cable. In the embodiment, the external device is charged and/or powered via a charging cable (not shown) to be connected to the charging port 8.

In an embodiment, a light source 20 is further provided with a bottom cap 12 to retain the contents and batteries of held within the 360-degree production light. In an embodiment, the bottom cap 12 is fastened to the bottom of the 360-degree production light via one or more screws 10 which are threaded into battery frame 7. In another embodiment, the light shield disc 4 may separate from the top cap 15. In said embodiment, the light shield disc 4 may attach to the top cap 15 via screws. In another embodiment, the light shield disc 4 may also be threaded on to the threaded attachment 3, via a threaded aperture provided in the center of the light shield disc 4. In an embodiment, the bottom cap 12 is further provided with a threaded cavity, such that multiple 360-degree production lights may be attached and stacked on top of one another to emit a greater light intensity.

In one embodiment, the top cap 15 and bottom cap 12 are made of plastic. However, in other embodiments the top cap and bottom cap may be made of another material which provides protection for the internal components of the unit while remaining light in weight, such as aluminum, carbon fiber, or another polymer or composite material.

In an embodiment, the 360-degree production light 20 is further provided with a power switch 9. In an embodiment, the power switch is a multi-mode power switch and enables a user to toggle between different light intensity settings, as is known in the art. In another embodiment, the 360-degree production light is provided with a dimming knob. In an embodiment, the dimming knob allows the user to adjust the light intensity of the production light. In an embodiment, the dimming knob may also contain a power switch, such that a user can turn the power of the production light off by moving the rotating the knob to the farthest adjustment, as is known in the art.

In an embodiment, the 360-degree production light 20 is further provided with a remote control operation system. In the embodiment, the remote control operation is processed via radio frequency (RF), but may be infrared (IR), Bluetooth, or another means of remote communication as deemed appropriate by one skilled in the art. In an embodiment, the remote control system should allow a user to control the power, light intensity, flash, strobe effect, or other functions of the 360-degree production light 20 at a distance. In an embodiment, wherein Bluetooth remote communication is utilized, a user may be able to control one or more 360-degree production lights using a software application downloaded on the user's electronic device. In another embodiment, the 360-degree production light 20 may be connected with the attached camera to provide a flash upon taking a picture. In this embodiment, the 360-degree production light 20 would be triggered from an attached camera, for example. In such an embodiment, the electronic circuitry (not shown) for the remote control operation may be housed in cavity 16 provided between the battery frame 7 and bottom lid 12.

In an embodiment, the production light 20 is further configured with display 17. In an embodiment, the display 17 provides the user with the status of the light and may include indications such as power status, charge status, remote connection status, and other information which would be considered important to a user of the production light. The display may be of be a liquid crystal type, LED type, or another display type deemed suitable.

In an embodiment, the production light 20 is further provided with threaded cavity 14, wherein the threaded cavity allows the light to receive the threaded attachment of a tripod (not shown). In another embodiment, the threaded cavity 14 allows for engagement with a second production light 20. In the embodiment, the threaded attachment 3 of the second production light is received by the threaded cavity 14 of the first production light. This configuration allows multiple productions lights 20 to be stacked to produce a greater light intensity than possible with a single production light.

In an embodiment, multiple 360-degree production lights may be combined using a modular system, wherein multiple production lights are electrically connected to a primary production light attached to a camera. In an embodiment, the threaded attachment 3 of the secondary production light is in electric connection with an electrically active threaded cavity 14 provided on the bottom of the primary production light. In an embodiment, the secondary production light is further provided with an electrically active threaded attachment 3, such that an additional secondary production light may be electrically attached. In said embodiment, multiple secondary lights may be linked together such that all production lights operate in a mode specified by the primary production light.

In another embodiment, the secondary production light is in electrical connection with the primary production light via a cable connection, which may of a USB type in some embodiments. In one embodiment, each production light is provided with an independent power supply. In another embodiment, the primary and secondary production lights are electronically connected to share a power source, for example. In another embodiment, the primary and secondary production lights are wirelessly connected via Bluetooth, IR, radio, or another wireless means deemed appropriate. In the embodiment, a user may specify the primary production light to control the light mode of the secondary lights.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein.

I claim:

1. A production light comprising:
a light emitting diode array operable to simultaneously project light about a 360 degree angle;
an internal power source operable to power the light emitting diode array; and
a threaded connector, configured to receive a camera, positioned above the light emitting diode array.

2. The production light of claim 1, further comprising a top lid above the light emitting diode array, and a bottom lid below the light emitting diode array.

3. The production light of claim 2, wherein the top lid further comprises a light shield disc.

4. The production light of claim 2, further comprising a transparent guard held between the top lid and the bottom lid and surrounds the light emitting diode array.

5. The production light of claim 2, wherein the bottom lid further comprises a display.

6. The production light of claim 1, wherein the internal power source is comprised of one or more batteries.

7. The production light of claim 6, wherein the one or more batteries are rechargeable type batteries.

8. The production light of claim 4, wherein the transparent guard is a light filter.

9. The production light of claim 4, further comprising a light filter provided between the light emitting diode array and the transparent guard.

10. A production light comprising:
an internal power source;
a shell enclosing the power source;
a light emitting diode array provided on an outside surface of the shell;
and a threaded connector positioned above the light emitting diode array;
wherein the light emitting diode array projects light about a 360 degree angle, and the threaded connector is configured to be received by a threaded aperture provided on the bottom of a camera.

11. The production light of claim 10, further comprising a top lid above the light emitting diode array, and a bottom lid below the light emitting diode array.

12. The production light of claim 11, wherein the top lid further comprises a light shield disc.

13. The production light of claim 11, further comprising a transparent guard held between the top lid and the bottom lid and surrounds the light emitting diode array.

14. The production light of claim 11, wherein the bottom lid further comprises a display.

15. The production light of claim 10, wherein the internal power source is comprised of one or more batteries.

16. The production light of claim 10, further comprising a power switch configured to adjust an light intensity emitted by the light emitting diode array.

17. The production light of claim 13, wherein the transparent guard is a light filter.

18. A production light comprising:
an internal power source;
a shell having an inner surface, an outer surface, a top, and a bottom, wherein the inner surface surrounds the internal power source;
a light emitting diode array provided on the outside surface of the shell;
a top lid provided abutting the top of the shell;
a bottom lid abutting the bottom of the shell;
a transparent guard held between the top lid and the bottom lid and surrounding the light emitting diode array
and a threaded connector positioned above the light emitting diode array and extending through the top lid;
wherein the light emitting diode array projects light about a 360 degree angle, and the threaded connector is configured to receive a camera.

19. The production light of claim 18, wherein the top lid further comprises a light shield disc.

20. The production light of claim 18, wherein the transparent guard is a light filter.
